(19) United States
(12) Patent Application Publication
(10) Pub. No.: US 2006/0056773 A1
(43) Pub. Date: Mar. 16, 2006

(54) Optical transceiver module

(76) Inventors: Rui-Shen Tsai, Kaohsiung Hsien (TW); Chih-Wei Chien, Tainan City (TW); Ying-Jie Chen, Kaohsiung Hsien (TW); Yi-Chen Huang, Chiayi Hsien (TW)

Correspondence Address: PITNEY HARDIN LLP, 7 TIMES SQUARE, NEW YORK, NY, 10036-7311, US

(21) Appl. No.: 10/940,046

(22) Filed: Sep. 14, 2004

(51) Int. Cl. G02B 6/36

(52) U.S. Cl. 385/89; 385/88; 385/92

(57) ABSTRACT

An optical transceiver module includes an outer cage, a socket member, a locking mechanism, and a release mechanism. The socket member is disposed removably in the outer cage. The locking mechanism is provided on the outer cage and the socket member, and serves to lock releasably the socket member to the outer cage. The release mechanism is mounted rotatably on the socket member, and is formed with a wedge part that is in sliding engagement with the locking mechanism such that rotation of the wedge part of the release mechanism relative to the socket member drives the locking mechanism between a locking state, where the socket member is locked to the outer cage, and an unlocking state, where the socket member is removable from the outer cage.

### BACKGROUND OF THE INVENTION

1. Field of the Invention

The present invention relates to an optical transceiver module, more particularly to an optical transceiver module including a rotary release mechanism for actuating a locking mechanism that locks releasably a socket member to an outer cage.

2. Description of the Related Art

A conventional optical transceiver module employed in fiber optic devices includes an outer cage, a socket member disposed removably in the outer cage, and a resilient latching tab and a locking protrusion that constitute a locking mechanism for locking releasably the socket member to the outer cage. A key is operable so as to drive movement of the latching tab to permit removal of the socket member from the outer cage. The aforesaid conventional optical transceiver module is disadvantageous in that the key is easily misplaced. Moreover, it is relatively inconvenient to drive movement of the latching tab with the use of the relatively small key.

### SUMMARY OF THE INVENTION

Therefore, the object of the present invention is to provide an optical transceiver module which includes a rotary release mechanism for actuating a locking mechanism that locks releasably a socket member to an outer cage.

Accordingly, the optical transceiver module of the present invention comprises an outer cage, a socket member, a locking mechanism, and a release mechanism. The socket member is disposed removably in the outer cage. The locking mechanism is provided on the outer cage and the socket member, and serves to lock releasably the socket member to the outer cage. The release mechanism is mounted rotatably on the socket member, and is formed with a wedge part that is in sliding engagement with the locking mechanism such that rotation of the wedge part of the release mechanism relative to the socket member drives the locking mechanism between a locking state, where the socket member is locked to the outer cage, and an unlocking state, where the socket member is removable from the outer cage.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of the first preferred embodiment of an optical transceiver module according to the present invention;

FIG. 2 is a fragmentary, partly exploded, perspective view of the first preferred embodiment;

FIG. 3 is a fragmentary schematic bottom view of the first preferred embodiment when a locking mechanism thereof is in a locking state;

FIG. 4 is a fragmentary assembled perspective view of the first preferred embodiment, illustrating how the locking mechanism is driven by a release mechanism to an unlocking state;

FIG. 5 is a fragmentary schematic bottom view of the first preferred embodiment when the locking mechanism is in the unlocking state;

FIG. 6 is a fragmentary, partly exploded, perspective view of the second preferred embodiment of an optical transceiver module according to the present invention;

FIG. 7 is an inverted perspective view of a release mechanism of the second preferred embodiment;

FIG. 8 is a fragmentary exploded perspective view of the third preferred embodiment of an optical transceiver module according to the present invention;

FIG. 9 is a perspective view of a release mechanism of the third preferred embodiment;

FIG. 10 is a fragmentary assembled perspective view of the third preferred embodiment when a locking mechanism thereof is in a locking state;

FIG. 11 is a fragmentary assembled sectional view of the third preferred embodiment when the locking mechanism is in a locking state;

FIG. 12 is a fragmentary assembled perspective view of the third preferred embodiment when the locking mechanism is in an unlocking state; and

FIG. 13 is a fragmentary assembled sectional view of the third preferred embodiment when the locking mechanism is in the unlocking state.

### DETAILED DESCRIPTION OF THE PREFERRED EMBODIMENTS

Before the present invention is described in greater detail with reference to the preferred embodiments, it should be noted herein that like elements are denoted by the same reference numerals throughout the accompanying disclosure.

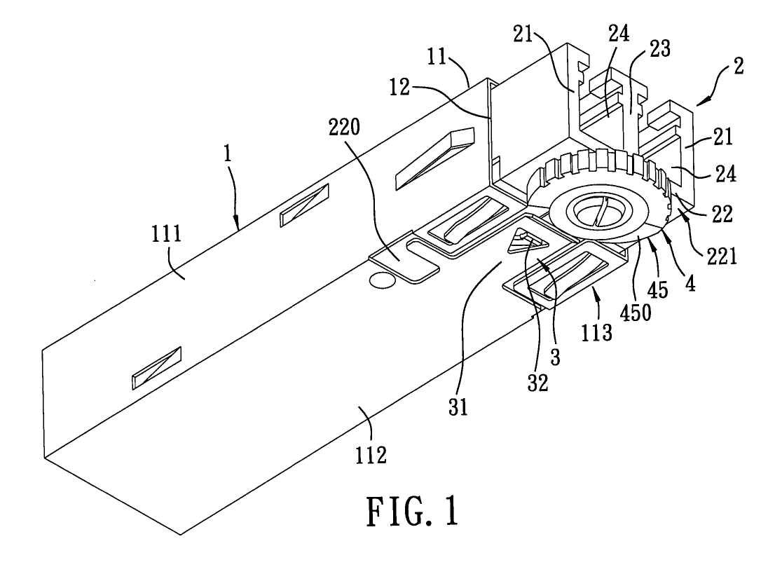

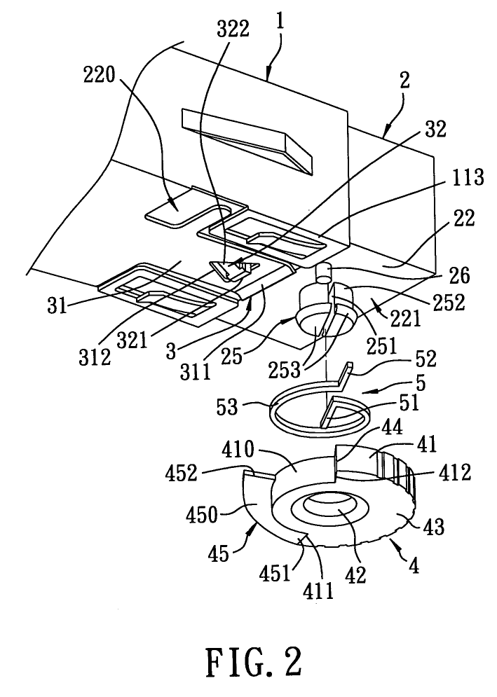

Referring to FIGS. 1 and 2, the first preferred embodiment of an optical transceiver module according to the present invention is shown to include an outer cage 1, a socket member 2, a locking mechanism 3, a release mechanism 4, and a restoring unit 5.

The outer cage 1 includes a surrounding wall 11 that has a rectangular cross-section and that defines a socket receiving space 12. The surrounding wall 11 includes a pair of lateral wall portions 111 and a bottom wall portion 112 interconnecting bottom edges of the lateral wall portions 111. The bottom wall portion 112 is formed with a latching end part 113.

The socket member 2 has a cage engaging portion 220 to be disposed removably in the socket receiving space 12, and amounting portion 221 to be disposed externally of the outer cage 1. The socket member 2 includes a pair of lateral walls 21, a bottom wall 22 interconnecting bottom edges of the lateral walls 21, and a partition wall 23 extending upwardly from the bottom wall 22 and disposed between the lateral walls 21, thereby configuring the socket member 2 with a pair of socket holes 24. The socket member 2 further includes an axle 25 and a limit member 26 formed on the mounting portion 221 at the bottom wall 22 of the socket member 2. The axle 21 is formed with an axially extending slit 251 that configures the axle 25 with a pair of resilient axle parts 252, each of which is formed with a radial outward flange 253. In practice, there are various electronic components, such as a printed circuit board, contact members, etc., mounted in the socket member 2 to enable connection with fiber optic cables. However, since the components in the socket member 2 are known in the art and are not pertinent to the claimed invention, a detailed description of the same is dispensed with herein for the sake of brevity.

The locking mechanism 3 is provided on the outer cage 1 and the socket member 2, and serves to lock releasably the socket member 2 to the outer cage 1. In this embodiment, the locking mechanism 3 includes a resilient tab 31 provided on the latching end part 113 of the outer cage 1 and formed with a curved actuated edge 311 and a locking hole 312, and a locking protrusion 32 provided on the bottom wall 22 of the socket member 2 and to be registered with the locking hole 312. The locking protrusion 32 extends into the locking hole 312 to lock the socket member 2 to the outer cage 1 when the locking mechanism 3 is disposed at a locking state. The locking protrusion 32 is formed with a stop surface 321 that extends downwardly from the socket member 2, and a guide surface 322 that extends inclinedly from the stop surface 321 to the socket member 2 in a direction away from the axle 25.

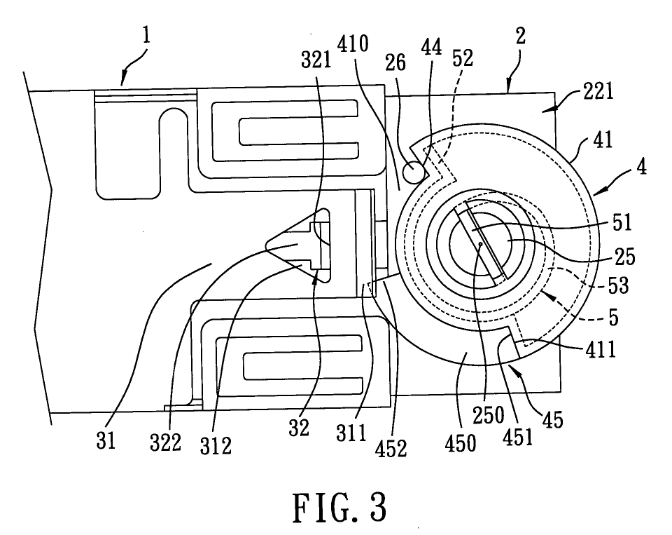

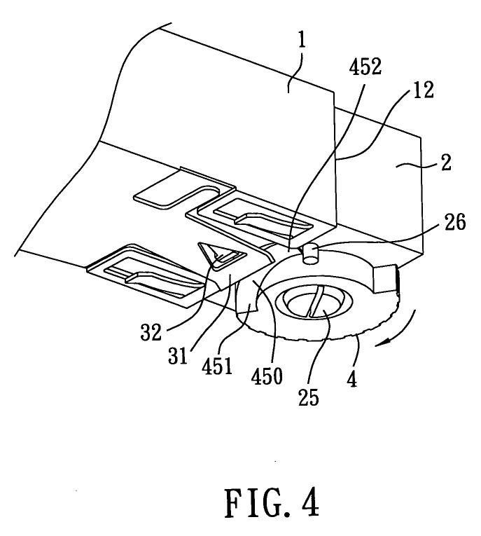

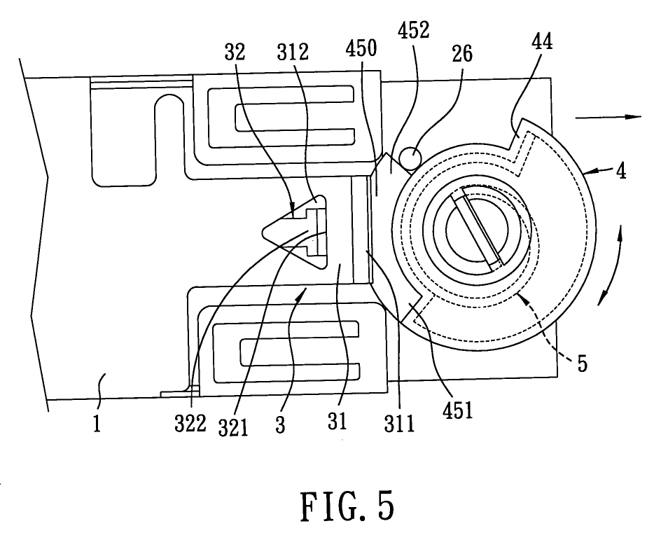

With further reference to FIG. 3, the release mechanism 4 is mounted rotatably on the axle 25 of the socket member 2, and includes a rotary knob having an annular inner knob portion 42, an annular outer knob portion 41 that surrounds the inner knob portion 42 and that is formed with a wedge part 45, and an annular base wall 43 that interconnects bottom edges of the inner and outer knob portions 42, 41. The axle 25 extends through the inner knob portion 42 such that the radial outward flanges 253 on the axle parts 252 engage the base wall 43, thereby retaining rotatably the inner knob portion 42 on the axle 25. The outer knob portion 41 is formed with a circumferentially extending cutout 410 having opposite first and second ends 411, 412 that are angularly spaced apart with respect to the axle 25. The wedge part 45 extends from the first end 411 of the cutout 410. In particular, the wedge part 45 extends along an arc with respect to an axis 250 (see FIG. 3) of the axle 25, and has an inclined pushing surface 450 with angularly spaced apart first and second edges 451, 452 that form a height difference therebetween. In this embodiment, the first edge 451 is proximate to the first end 411 of the cutout 410, and is disposed lower than the second edge 452. The pushing surface 450 of the wedge part 45 extends between the bottom wall 22 of the socket member 2 and the actuated edge 311 of the resilient tab 31 of the locking mechanism 3, and is in sliding engagement with the actuated edge 311 of the resilient tab 31 such that rotation of the wedge part 45 relative to the socket member 2 about the axle 25 can drive the resilient tab 31 to flex away from the bottom wall 22 of the socket member 2 so as to disengage the locking protrusion 32 from the locking hole 312 in the resilient tab 31, thereby disposing the locking mechanism 3 at an unlocking state to permit removal of the socket member 2 from the outer cage 1, as best shown in FIGS. 4 and 5.

Furthermore, the second end 412 of the cutout 410 is formed with a stop wall 44. The limit member 26 extends into the cutout 410 between the wedge part 45 and the stop wall 44, and cooperates with the second edge 452 of the wedge part 45 and the stop wall 44 to limit extent of angular rotation of the rotary knob relative to the socket member 2.

The restoring unit 5 urges the release mechanism 4 such that the locking mechanism 3 is normally disposed at the locking state, as best shown in FIG. 3. In this embodiment, the restoring unit 5 includes a torsion spring having a mounting segment 51 coupled to the axle 25, a biasing segment 52 coupled to and acting on the rotary knob of the release mechanism 4, and a connecting segment 53 interconnecting the mounting and biasing segments 51, 52.

Referring again to FIGS. 1 and 3, in operation, when the locking mechanism 3 is at the locking state, the locking protrusion 32 on the bottom wall 22 of the socket member 2 engages the locking hole 312 in the resilient tab 31 on the outer cage 1. Hence, the socket member 2 is locked to the outer cage 1 so as to prevent uprooting of the former from the socket receiving space 12. At this time, the rotary knob of the release mechanism 4 is biased by the restoring unit 5 such that the stop wall 44 abuts against the limit member 26, and such that the second edge 452 of the pushing surface 450 of the wedge part 45 is disposed between the bottom wall 22 of the socket member 2 and the actuated edge 311 of the resilient tab 31.

Referring to FIGS. 4 and 5, when it is desired to remove the socket member 2 from the outer cage 1, a force is exerted to rotate the rotary knob of the release mechanism 4 against the biasing force of the restoring unit 5 such that the first edge 451 of the pushing surface 450 is moved toward the actuated edge 311 of the resilient tab 31. In view of the height difference between the first and second edges 451, 452 of the pushing surface 450, the resilient tab 31 is driven to flex away from the bottom wall 22 of the socket member 2 so as to disengage the locking protrusion 32 on the bottom wall 22 of the socket member 2 from the locking hole 312 in the resilient tab 31 on the outer cage 1, thereby disposing the locking mechanism 3 at the unlocking state. The socket member 2 can be removed from the socket receiving space 12 of the outer cage 1 at this time. Note that when the force exerted on the release mechanism 4 is relieved, the release mechanism 4 is restored to its initial position shown in FIG. 3 by virtue of the restoring unit 5.

Thereafter, when the socket member 2 is subsequently inserted into the outer cage 1, the guide surface 322 of the locking protrusion 32 functions to push the actuated edge 311 of the resilient tab 31 away from the bottom wall 22 of the socket member 2 until the locking protrusion 32 is aligned with the locking hole 312 in the resilient tab 31. The stop surface 321 of the locking protrusion 32 then engages the periphery of the locking hole 312 to once again lock the socket member 2 to the outer cage 1.

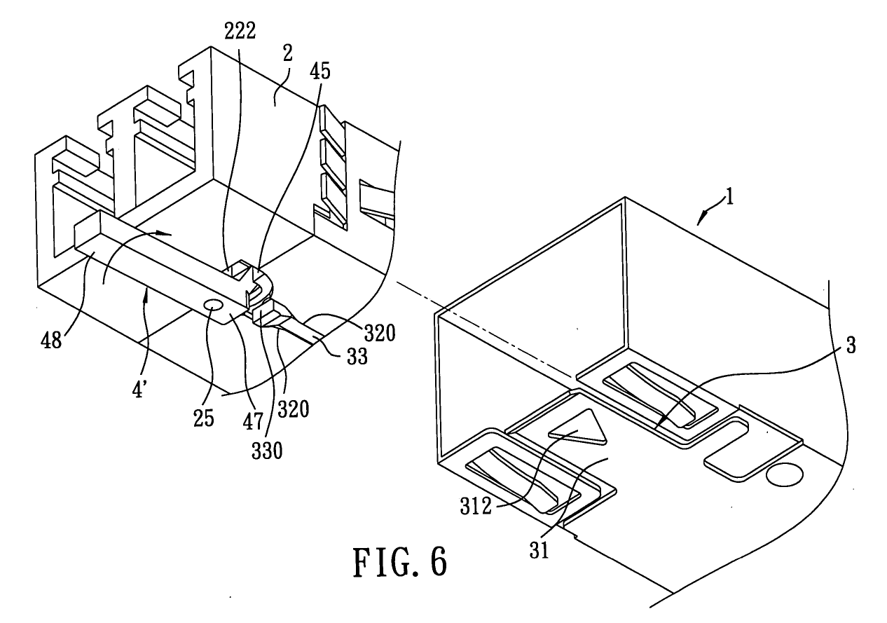

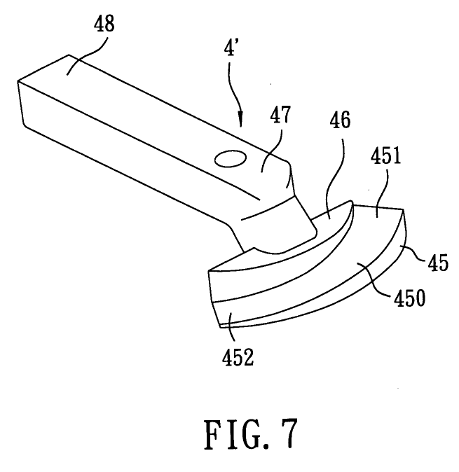

Referring to FIGS. 6 and 7, the second preferred embodiment of an optical transceiver module according to this invention is shown to likewise include an outer cage 1, a socket member 2, a locking mechanism 3, and a release mechanism 4′. In this embodiment, the locking mechanism 3 includes a tab 31 provided on the outer cage 1 and formed with a locking hole 312, and a resilient locking member 33 provided on the socket member 2. Two slits 320 in the outer cage 1 permit flexing of the locking member 33. The locking member 33 is formed with a distal engaging part 330 to engage the locking hole 312.

The socket member 2 is formed with an access hole 222 proximate to the distal engaging part 330 of the locking member 33. The release mechanism 4′ includes an actuator portion 46, a pivot portion 47 connected to the actuator portion 46 and mounted rotatably on the axle 25 of the socket member 2, and an operating portion 48 extending from the pivot portion 47. The actuator portion 46 extends into the access hole 222, and is formed with the wedge part 45. Like the previous-embodiment, the wedge part 45 extends along an arc with respect to the axle 25, and has an inclined pushing surface 450 with angularly spaced apart first and second edges 451, 452 that form a height difference therebetween. The pushing surface 450 of the wedge part 45 is in sliding engagement with the distal engaging part 330 of the locking member 33. By rotating the wedge part 45 relative to the socket member 2, the locking member 33 moves to engage or disengage the distal engaging part 330 from the locking hole 312. In particular, when the operating portion 48 is operated such that the first edge 451 of the inclined pushing surface 450 abuts against the distal engaging part 330 of the locking member 33, the locking member 33 is driven to flex such that the distal engaging part 330 engages the locking hole 312, thereby disposing the locking mechanism 3 at the locking state. On the other hand, when the operating portion 48 is operated such that the second edge 452 of the inclined pushing surface 450 abuts against the distal engaging part 330 of the locking member 33, since the second edge 452 is at a higher position than the first edge 451, the locking member 33 is restored to its initial state by virtue of its own resiliency such that the distal engaging part 330 disengages from the locking hole 312, thereby disposing the locking mechanism 3 at the unlocking state.

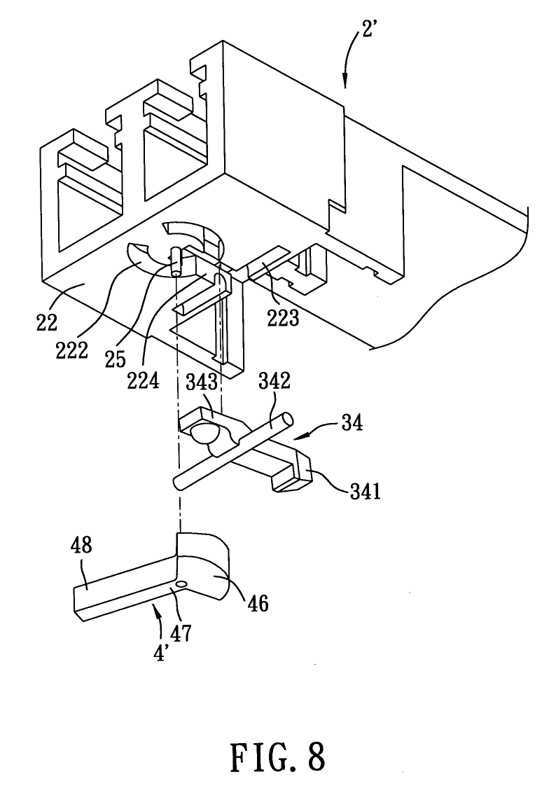

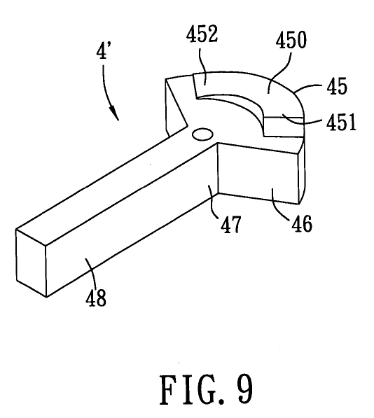

Referring to FIGS. 8 to 11, the third preferred embodiment of an optical transceiver module according to this invention is shown to also include an outer cage 1, a socket member 2′, a locking mechanism 3′, and a release mechanism 4′. Unlike the previous embodiments, the bottom wall 22 of the socket member 2 is formed with a curved slit 222 surrounding the axle 25, a transverse groove 224 transverse to a longitudinal direction of the socket member 2′, and a longitudinal slit 225 that extends from the curved slit 222 to the transverse groove 224. The locking mechanism 3′ includes a locking hole 312 formed in the outer cage 1, and a latch member 34 having an engaging portion formed with a locking protrusion 341 to be registered with the locking hole 33, a pivot portion 342 connected to the engaging portion and retained pivotally in the transverse groove 224, and an actuated portion 343 extending from the pivot portion 313 and disposed above the curved slit 222.

The release mechanism 4′ of this embodiment is similar to that of the second preferred embodiment. In particular, the release mechanism 4′ includes an actuator portion 46 formed with the wedge part 45 that is slidable in the curved slit 222 and that is in sliding engagement with the actuated portion 343 of the latch member 34, a pivot portion 47 connected to the actuator portion 46 and mounted rotatably on the axle 25 of the socket member 2′, and an operating portion 48 extending from the pivot portion 47 of the release mechanism 4′. The wedge part 45 includes an inclined pushing surface 450 with angularly spaced apart first and second edges 451, 452 that form a height difference therebetween. Since the actuated portion 343 of the latch member 34 is slightly heavier than the engaging portion, abutment between the actuated portion 343 and the inclined pushing surface 450 is ensured.

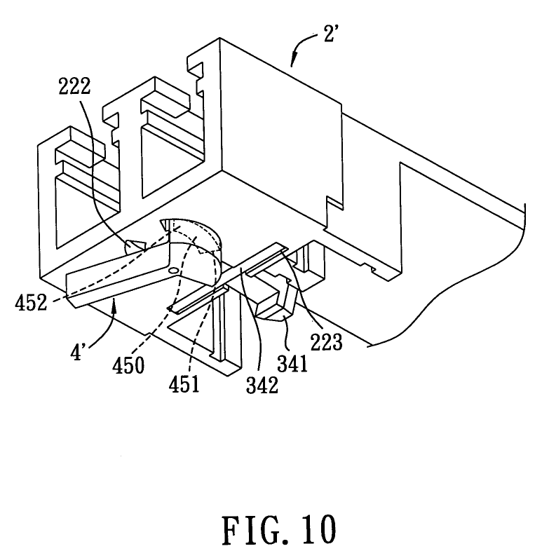

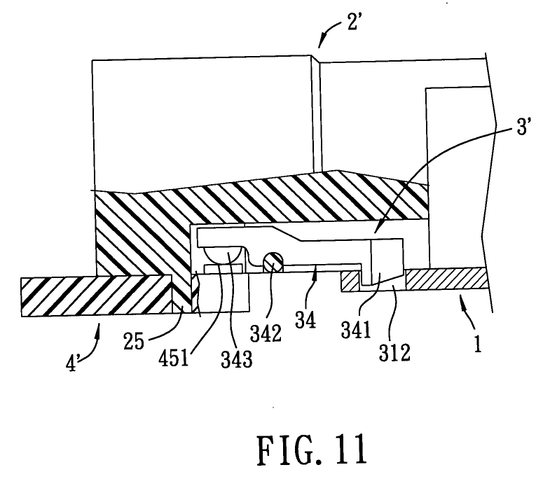

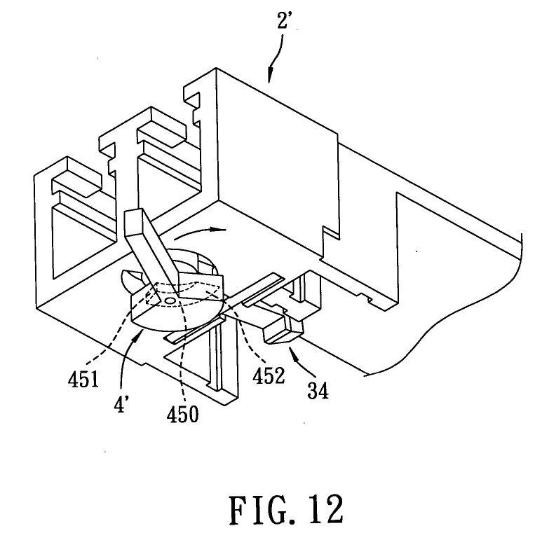

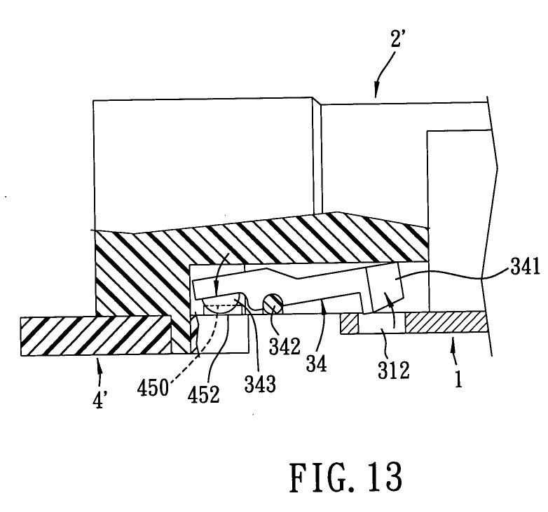

By rotating the wedge part 45 relative to the socket member 2′, the latch member 34 can pivot so as to engage or disengage the locking protrusion 341 on the engaging portion from the locking hole 312. In particular, with reference to FIGS. 10 and 11, when the operating portion 48 is operated such that the first edge 451 of the inclined pushing surface 450 abuts against the actuated portion 343 of the latch member 34, the latch member 34 is forced to pivot about the pivot portion 342 such that the locking protrusion 341 engages the locking hole 312, thereby disposing the locking mechanism 3′ at the locking state. On the other hand, with reference to FIGS. 12 and 13, when the operating portion 48 is operated such that the second edge 452 of the inclined pushing surface 450 abuts against the actuated portion 343 of the latch member 34, since the second edge 452 is at a lower position than the first edge 451, the latch member 34 pivots about the pivot portion 342 due to the heavier weight of the actuated portion 343 such that the locking protrusion 341 disengages from the locking hole 312, thereby disposing the locking mechanism 3′ at the unlocking state.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. (canceled)

2. An optical transceiver module comprising:
an outer cage;
a socket member disposed removably in said outer cage;
a locking mechanism, provided on said outer cage and said socket member, for locking releasably said socket member to said outer cage; and
a release mechanism mounted rotatable on said socket member and formed with a wedge part that is in sliding engagement with said locking mechanism such that rotation of said wedge part of said release mechanism relative to said socket member drives said locking mechanism between a locking state, where said socket member is locked to said outer cage, and an unlocking state, where said socket member is removable from said outer cage;
wherein said socket member has a cage engaging portion to be received in said outer cage, and a mounting portion to be disposed externally of said outer cage and formed with an axle for mounting rotatably said release mechanism on said socket members;
said wedge part extending along an arc with respect to said axle, and having angularly spaced apart first and second edges that form a height difference therebetween.

3. The optical transceiver module as claimed in claim 2, wherein said release mechanism includes a rotary knob having an inner knob portion that is retained rotatably on said axle, and an outer knob portion that surrounds said inner knob portion and that is formed with said wedge part.

4. The optical transceiver module as claimed in claim 3, wherein said axle is formed with an axially extending slit that configures said axle with a pair of resilient axle parts, each of said axle parts being formed with a radial outward flange for retaining said rotary knob rotatably on said axle.

5. The optical transceiver module as claimed in claim 3, wherein said outer knob portion is formed with a circumferentially extending cutout having opposite ends that are angularly spaced apart with respect to said axle, said wedge part extending from one of said ends of said cutout, the other one of said ends of said cutout being formed with a stop wall,
said mounting portion of said socket member being formed with a limit member that extends into said cutout between said wedge part and said stop wall, said limit member cooperating with said wedge part and said stop wall to limit extent of angular rotation of said rotary knob relative to said socket member.

6. The optical transceiver module as claimed in claim 2, further comprising a restoring unit for urging said release mechanism such that said locking mechanism is disposed at the locking state.

7. The optical transceiver module as claimed in claim 6, wherein said restoring unit includes a torsion spring having a mounting segment coupled to said axle, a biasing segment coupled to said release mechanism, and a connecting segment interconnecting said mounting and biasing segments.

8. An optical transceiver module comprising:
an outer cage;
a socket member disposed removably in said outer cage;
a locking mechanism, provided on said outer cage and said socket member, for locking releasably said socket member to said outer cage; and
a release mechanism mounted rotatable on said socket member and formed with a wedge part that is in sliding engagement with said locking mechanism such that rotation of said wedge part of said release mechanism relative to said socket member drives said locking mechanism between a locking state, where said socket member is locked to said outer cage, and an unlocking state, where said socket member is removable from said outer cage;
wherein said locking mechanism includes a resilient tab provided on said outer cage and formed with a locking hole, and a locking protrusion provided on said socket member and to be registered with said locking hole, said locking protrusion extending into said locking hole to lock said socket member to said outer cage when said locking mechanism is disposed at the locking state.

9. The optical transceiver module as claimed in claim 8, wherein said locking protrusion is formed with a stop surface that extends in an upright direction from said socket member, and a guide surface that extends inclinedly from said stop surface to said socket member.

10. The optical transceiver module as claimed in claim 8, wherein said wedge part is in sliding engagement with said resilient tab such that rotation of said wedge part relative to said socket member can drive said resilient tab to flex away from said socket member so as to disengage said locking protrusion from said locking hole, thereby disposing said locking mechanism at the unlocking state.

11. (canceled)

12. An optical transceiver module comprising:
an outer cage;
a socket member disposed removably in said outer cage;
a locking mechanism, provided on said outer cage and said socket member, for locking releasably said socket member to said outer cage; and
a release mechanism mounted rotatable on said socket member and formed with a wedge part that is in sliding engagement with said locking mechanism such that rotation of said wedge part of said release mechanism relative to said socket member drives said locking mechanism between a locking state, where said socket member is locked to said outer cage, and an unlocking state, where said socket member is removable from said outer cage;
wherein said locking mechanism includes a locking hole formed in said outer cage, and a resilient locking member provided on said socket member and formed with an engaging part to engage said locking hole;
wherein said socket member is formed with an access hole proximate to said engaging part of said locking members;
said release mechanism including an actuator portion, a pivot portion connected to said actuator portion and mounted rotatably on said socket member, and an operating portion extending from said pivot portion;
said actuator portion extending into said access hole and being formed with said wedge part that is in sliding engagement with said engaging part of said locking member; and
wherein rotation of said wedge part relative to said socket member can drive said locking member to engage said engaging part with said locking hole, thereby disposing said locking mechanism at the locking state.

13. An optical transceiver module comprising:
an outer cage;
a socket member disposed removably in said outer cage;
a locking mechanism, provided on said outer cage and said socket member, for locking releasably said socket member to said outer cage; and
a release mechanism mounted rotatably on said socket member and formed with a wedge part that is in sliding engagement with said locking mechanism such that rotation of said wedge part of said release mechanism relative to said socket member drives said locking mechanism between a locking state, where said socket member is locked to said outer cage, and an unlocking state, where said socket member is removable from said outer cage;
said locking mechanism including a locking hole formed in said outer cage, and a latch member having an engaging portion formed with a locking protrusion to be registered with said locking hole, a pivot portion connected to said engaging portion and retained pivotally on said socket member, and an actuated portion extending from said pivot portion;
said release mechanism including an actuator portion formed with said wedge part that is in sliding engagement with said actuated portion of said latch member, a pivot portion connected to said actuator portion and mounted rotatably on said socket member, and an operating portion extending from said pivot portion of said release mechanism;
wherein rotation of said wedge part relative to said socket member can drive said latch member to pivot such that said locking protrusion engages said locking hole, thereby disposing said locking mechanism at the locking state.

14. The optical transceiver module as claimed in claim 13, wherein said actuated portion is heavier than said engaging portion.
